(19) United States
(12) Patent Application Publication
(10) Pub. No.: US 2006/0080817 A1
(43) Pub. Date: Apr. 20, 2006

(54) Method of forming a furniture article using heat-shrinkable material, and article formed therefrom

(76) Inventor: Scott Klinker, Bloomfield Hills, MI (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/968,660

(22) Filed: Oct. 19, 2004

(51) Int. Cl. B68G 7/00

(52) U.S. Cl. 29/91.1; 29/447

(57) ABSTRACT

Disclosed is a method of making an article for furniture, lighting products, architectural applications and the like. A nonwoven heat-shrinkable fiber sleeve is fitted onto a three-dimensional wire frame so that the wire frame is inside the sleeve and the sleeve surrounds at least a portion of the frame. The assembly is heated. The fiber sleeve bonds to the wire frame, shrinks and hardens with cooling. Also disclosed is a technique for forming components such as furniture panels from expandable frames positioned within flexible sleeve members.

### BACKGROUND

The present invention relates to a method of making an article of furniture, particularly a chair and the article or chair produced therefrom. In particular, the present invention relates to the use of a heat-shrinkable material in forming a furniture article. The present invention also relates to a technique of incorporating a frame component within a flexible member.

An article of furniture, such as a chair, can be constructed in many different ways. Generally, the various pieces comprising a chair are first individually constructed, such as the structure or supporting frame, the upholstery, the cushions, arms and so forth. These pieces are then mechanically fastened together using fasteners such as screws, nails, glue, staples, and the like to form the chair. However, these pieces generally do not support each other in a way that increases the overall strength of the chair. For example, the fasteners holding one arm to the back of the chair may be pulled out while the other arm remains structurally intact.

When covering a chair with a fabric, conventional processes for form-fitting fabric to chair cushions and frames may involve manually pulling and stretching a cover to eliminate wrinkles while, at the same time, attaching the cover to the frame. Such manual form-fitting processes are labor intensive and costly.

It is an object of the present invention to form a furniture article having a greater strength than the sum of the strengths of its constituent components when used alone.

It is another object of the invention to provide a furniture article which is springy and flexible to fit and accommodate a person, yet which is strong and durable.

It is another object of the present invention to provide a method for making such an article that is highly economical and requires little investment in manufacturing capability.

### BRIEF DESCRIPTION

An article of furniture, particularly a chair, is produced according to the present invention by providing at least one sleeve comprised of a heat-shrinkable fabric or layer of non-woven fibrous material. The sleeve is fitted over at least a portion of a three-dimensional frame and the entire assembly is heated. The sleeve shrinks as it is heated and hardens as it cools so that it is secured to the frame, thereby imparting rigidity to both the hardened sleeve and the frame.

Specifically, in accordance with a first aspect of the present invention, a method is provided for manufacturing an article of furniture from at least one flexible sleeve that shrinks upon being heated and a frame. The method comprises fitting the sleeve onto the frame so that the frame is located within the sleeve to thereby form an assembly. The method also comprises a step of heating the assembly to thereby shrink the sleeve about the frame. And, the method includes a step of cooling the assembly to thereby harden the sleeve.

In accordance with another aspect of the present invention, a method of manufacturing a chair from a sleeve exhibiting heat-shrink characteristics and a three-dimensional wire frame is provided. The method comprises a step of fitting the sleeve onto the wire frame so that the wire frame is located within the sleeve to form an assembly. The method also includes a step of heating the assembly to a temperature in the range of from about 350° F. to about 450° F. for a period of time sufficient to cause the sleeve to shrink about the frame. The method also includes a step of cooling the assembly.

In accordance with another aspect of the present invention, a method is provided for forming an article having an internal frame disposed within a flexible heat-shrinkable sleeve. The method comprises providing an expandable frame assembly and providing a flexible heat-shrinkable sleeve. The method includes a step of inserting the frame assembly in the sleeve. The method also includes a step of expanding the frame assembly within the sleeve. And, the method includes a step of heating the sleeve to thereby cause the sleeve to contract about the expanded frame.

In accordance with another aspect of the present invention, a furniture article is provided comprising a frame and a sleeve member disposed about the frame. The sleeve member exhibits a heat-shrink property and has been heated to thereby induce shrinkage of the sleeve about the frame which in turn secures the sleeve member to the frame.

In accordance with yet another aspect of the present invention, an article of furniture is provided which comprises a frame defining a seat region, a back region, and a plurality of legs extending from the seat region and adapted for supporting the frame. The article of furniture also comprises a sleeve member extending within at least one of the seat region and the back region and secured to at least one of the seat and back regions. The sleeve member includes a heat-shrinkable material that upon exposure to a temperature in the range of from about 350° F. to about 450° F. shrinks by an amount of from about 1% to about 15%.

### BRIEF DESCRIPTION OF THE DRAWINGS

FIG. 1 is a perspective view of a three-dimensional wire frame used in a preferred embodiment chair according to the present invention.

FIG. 1A is a perspective view of an alternate three-dimensional wire frame used in a chair according to the invention.

FIG. 1B is a perspective view of another alternate three-dimensional wire frame used in a chair according to the invention.

FIG. 2 is a perspective view of a sleeve member fitted about a portion of the wire frame comprising the back of the chair.

FIG. 3 is a perspective view of the sleeve fitted over the wire frame prior to the assembly being heated.

FIG. 4 is a diagram showing a method of making a sleeve in accordance with the present invention.

FIG. 5 is an exploded view of an alternate sleeve assembly in accordance with the present invention.

FIG. 6 is a perspective view of a finished chair in accordance with the present invention.

FIG. 7 is a detail of the chair surface after heating.

FIG. 8 is a rear view of the chair showing the rear legs attached to the portion of the wire frame located inside or below the sleeve.

FIGS. 9A-9D illustrate a process and components used in that process for incorporating a frame component in a sleeve member and forming a panel therefrom, in accordance with the present invention.

### DETAILED DESCRIPTION

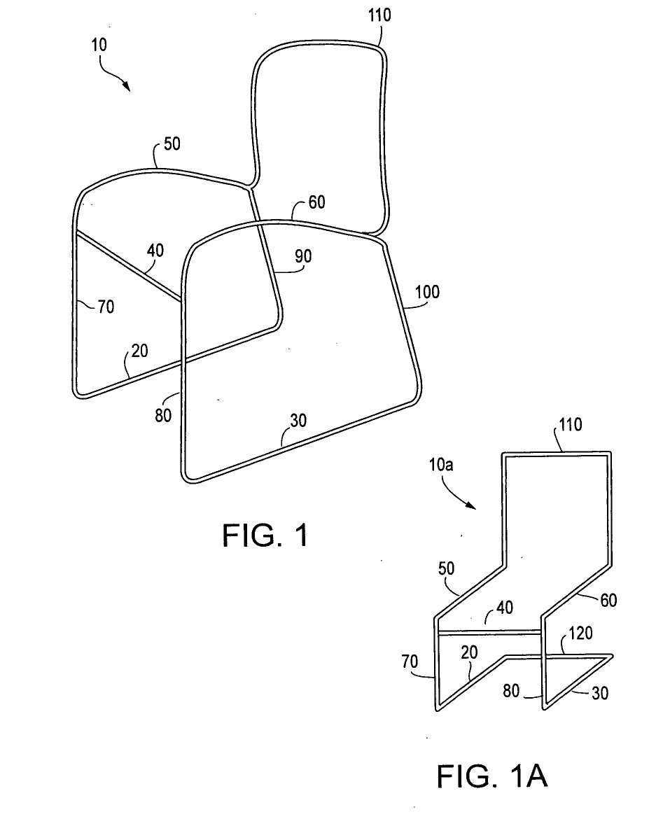

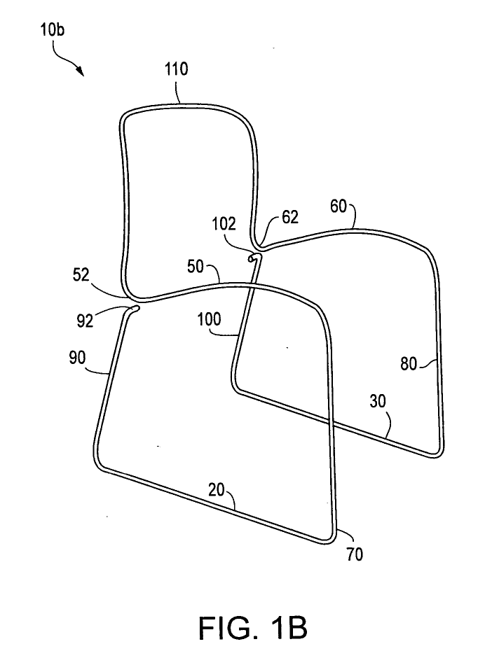

FIG. 1 depicts a three-dimensional wire frame 10 used in a preferred embodiment chair according to the present invention. As used herein, the term “wire” refers to the cross sectional shape of the material used in forming the frame rather than the shape of the frame itself; e.g., the wire frame is formed from a cylindrical or tube-shaped material that is formed into the shape of a chair. In one embodiment as shown in FIG. 1, the wire frame is defined by a first seat edge 50 and a second seat edge 60 which define the lateral sides of the seat of the chair; a first front leg 70 and first rear leg 90 joined together by a first floor support 20; a second front leg 80 and second rear leg 100 joined together by a second floor support 30; and a back support 110 which defines the back of the chair. The back support generally extends above the rear legs 90 and 100, and between the seat edges 50 and 60. The wire frame may be formed as one piece or as several pieces which are attached to each other. Here, the wire frame has been formed as two pieces. A first piece includes the four legs, the two floor supports, and the back support. The second piece includes the front cross support 40. However, in embodiments where the wire frame is comprised of more than one piece, each piece may comprise any combination or portion of the edges, legs, and supports listed above. For example, the back support may be made from two pieces. The pieces are not limited in quantity and may be joined by any method known in the art. The front cross support 40 provides additional strength, but does not need to be included. Additional pieces may be added as desired. For example, the wire frame may include multiple front cross-supports, a rear cross-support, or right and left cross-supports (not shown). These additional pieces are not limited by quantity or location. In addition, while the edges, legs, and supports here are generally shown as being straight or having small curves, they are not limited to this shape and may take any desired shape. For example, while the back support 110 is depicted as three sides of a square, it could take the shape of a circle, or portion thereof. The wire frame is intended to define the final three-dimensional shape of the chair, though other steps may also be used later in the manufacturing process to define the final shape of the chair (see below).

In general, the wire frame preferably includes at least two floor supports whose axes lie in a plane parallel to the floor and below the plane defined by the seat of the chair. However, in another embodiment not shown, the first front leg 70 and second front leg 80 could be joined by a front floor support while the first rear leg 90 and the second rear leg 100 would be joined by a rear floor support. In a third embodiment 10a as shown in FIG. 1A, the rear legs are eliminated. Instead, a rear floor support 120 joins the first floor support 20 and the second floor support 30 together. Preferably, only two floor supports are utilized because this allows chairs to be stacked together, saving space when the chairs are not in use.

FIG. 1B illustrates yet another configuration for the wire frame. In this version, a wire frame 10b utilizes first and second rear legs 90 and 100 which are not affixed to either a corresponding portion of seat edges 50 or 60, or to a portion of the back support 110. Instead, the first rear leg 90 defines a distal end 92 which is free, and not attached to a region 52 defined between the back support 110 and the seat edge 50. Similarly, the second rear leg 100 defines a distal end 102 which is free, and not attached to a region 62 defined between the back support 110 and the seat edge 60. Preferably, the distal ends 92 and 102 preferably extend at right angles from the corresponding portions of the rear legs 90 and 100.

Furthermore, the present invention includes the use of other frame configurations besides those described herein. For example, a frame configuration could be used which utilizes three, four, or more legs that extend vertically or substantially so, from the seat region of the frame. That is, horizontal floor supports 20 and 30, such as shown in FIGS. 1, 1A, and 1B, could be eliminated.

The wire frame may be made of any material which is rigid and can withstand high temperatures (350° F. to 450° F.) without melting. The frame may be made out of wood or metal, fiberglass, and/or plastic, but is preferably made of steel or iron. The material may take the form of a rod, tube, bent sheet, or any suitable shape. The frame may be hollow or solid. Although it is generally preferred that the frame be formed from a cylindrical or tube-shaped material, the present invention includes frames formed from materials having other configurations such as channels, angled members, or the like.

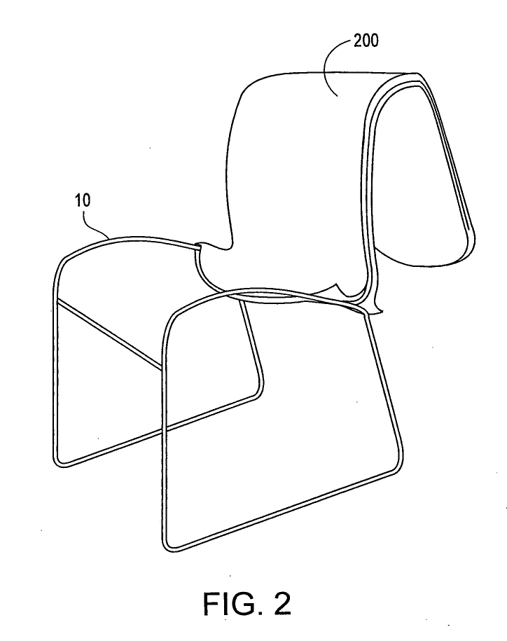

FIG. 2 shows a sleeve 200 partially fitted over the three-dimensional wire frame 10, and specifically the back support. The back support is located within the sleeve and so, not visible. As described in greater detail herein, the sleeve is preferably formed from a flexible, heat shrinkable material.

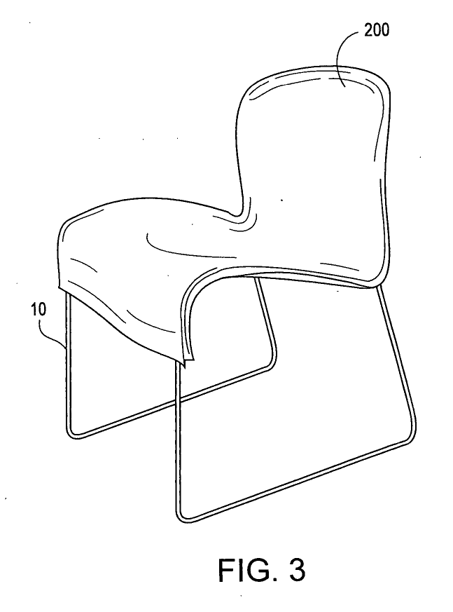

FIG. 3 shows the sleeve 200 completely fitted over the three-dimensional wire frame 10. As shown, the sleeve is fitted over the back of the chair and the seat of the chair. As used herein, the phrase “back of the chair” refers to a surface or portion of the frame for supporting a back of an occupant and the phrase “bottom (or seat) of the chair” refers to a surface or portion of the frame for supporting the buttocks or legs of an occupant. This embodiment should not be construed as requiring that the back of the chair and bottom of the chair be made from the same sleeve. In other embodiments, not shown, it may be desirable to use two different sleeves or one sleeve with different regions formed from different materials, to form the back of the chair and the bottom or seat of the chair.

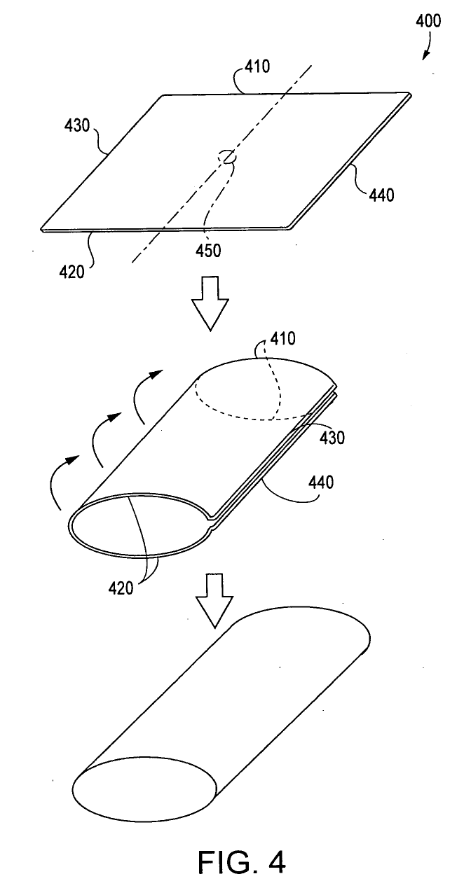

FIG. 4 illustrates a method of making a sleeve member suitable for use in the present invention, though any method known in the art suitable for making such a sleeve may be used. The sleeve is made from at least one flat sheet 400 comprised of a nonwoven fiber exhibiting a heat shrink property. The sheet 400 has a top edge 410, a bottom edge 420, a left side 430, and a right side 440. The fiber should be needle-punched to provide greater strength. A key property of the fiber is that it hardens or otherwise solidifies after it has been heated and retains the shape given to it as it cools. Generally, such fiber also has a key property of shrinking when heat is applied. The percentage of shrinkage depends on the fiber chosen. These two key properties are inherent in the fiber. The fiber can be polyvinyl chloride (PVC), polyolefin, or polyimide, but is preferably polyester. More preferably, the fiber is of a weight between 30 ounces and 60 ounces. Although nearly any commercially available fiber exhibiting the noted heat shrink property may be used, examples of preferred classes of fibers, include, but are not limited to Fortrel®, Spunnaire®, EcoSpun®, ConFortrel®, Fortel BactiShield®, Sensura®, Ultura®, and ComFortel® Plus from Wellman Polyesters. The preferred fibers exhibit a heat shrinkage at heating to 400° F. of from at least about 1% to about 15%, more preferably from about 2% to about 10%, and most preferably from about 4% to about 8%. Of course, the particular extent of shrinkage depends upon the process and end-use characteristics desired for the furniture article. The various extents of shrinkage are given with regard to the heat-shrinkable material prior to shrinkage. In addition, it is appreciated that heat-shrinkable materials or components formed therefrom, can undergo different degrees of shrinkage in different directions. For example, the present invention includes the use of a sleeve member formed from a layer of a heat-shrinkage nonwoven fiber that, upon heating, shrinks in a direction that corresponds to the width of the chair when the sleeve is placed over a frame (prior to heating). The degree of shrinkage in a direction perpendicular to the width direction, could in certain embodiments, be significantly greater or less.

The sleeve is preferably made by folding the fabric sheet 400 along an axis 450 so that the left side 430 and right side 440 form a seam. The left side 430 and right side 440 can then be joined at the seam using any method known in the art including, but not limited to, sewing them together with thread, adhesive, or heatstaking. However, they do not need to be joined along the entire length of the seam. Similarly, the top edge 410 now overlaps itself and is also joined together to create a sleeve. The resulting sleeve has a bag-like appearance. If desired, the bottom edge 420 may also be partially joined.

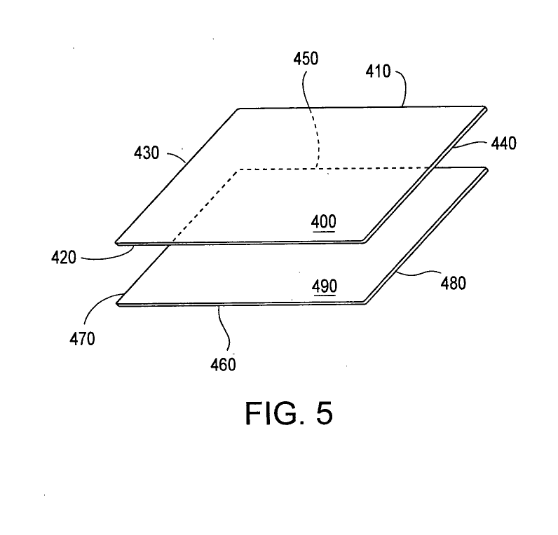

As shown in FIG. 5, the sleeve may also be made using a first fabric sheet 400 and a second fabric sheet 490. The first fabric sheet 400 has a first left side 430, first right side 440, first top edge 410, and first bottom edge 420. The second fabric sheet 490 has a second left side 470, second right side 480, second top edge 450, and second bottom edge 460. The two fabric sheets preferably have the same dimensions and are laid one on top of the other to form seams. The sleeve is made by joining the two fabric sheets at any three of the four seams together. In this example, the sleeve is made by joining the top edges 410 and 450 together at the top seam, the left sides 430 and 470 together at the left seam, and the right sides 440 and 480 together at the right seam. If desired, the bottom edges 420 and 460 may also be partially joined together at the left seam. However, the sleeve can be formed by joining any three of the seams together. For example, it may be desired to join the top, bottom, and right seams together so that the sleeve may be placed onto a wire frame from the left. There is no requirement that the two fabric sheets be joined along the complete length of a seam. It may also be desirable to join the sheets along only a partial length of a seam. For example, it may be desirable to join the sheets along the complete length of the top seam and only join the sheets along the top half of the right and left seams. The bottom half of the right and left seams could be joined together later in the manufacturing process or not at all.

Many other embodiments are contemplated within the present invention. While the edges and sides of the fabric sheet are depicted here as straight lines, they may have different shapes as desired for the final shape of the sleeve. For example, a curve may be desired for the top edge or a triangle-shaped sleeve may be desired. While this sleeve has been depicted as using only one layer of fabric, the invention also contemplates the use of multiple layers of fabric being used, in essence making one sleeve out of several smaller sleeves. When multiple layers are used, the layers which end up inside the sleeve may have smaller dimensions than the layers which end up on the outside of the sleeve in order to prevent bunching at seams or large voids between layers of the sleeve. If desired, padding may be placed within the sleeve. This padding may consist of foam or any other material that can withstand high temperatures. Other manufacturing steps can also affect the shape of the sleeve. For example, holes may be cut from the sleeve to expose parts of the wire frame located within the sleeve. This may aid in joining the pieces of the chair together or adding exterior structures to the chair. As noted, the sleeve member can utilize multiple layers of various materials in addition to a layer of heat shrink material. Other additional layers can include for example decorative layers, upholstered cushioned layers, or any type of fabric.

A significant advantage of the present invention relates to the use of a sleeve member which features at least two sides or regions of a layer forming the sleeve, fastened together. the fastening may be performed by nearly any method known in the art such as for example, sewing, adhesive, heat-staking, or sonic welding. That is, the present invention methods use a sleeve member or employ a step of fastening the noted edges together prior to heating the sleeve or material about the frame. This practice eliminates the need for molds or other forming surfaces, and so, greatly decreases the cost and complexity in manufacture.

Referring back to FIGS. 1, 2 and 3, the sleeve is fitted over portions of the wire frame so that those portions are located inside the sleeve. The sleeve should fit loosely to account for shrinkage induced upon heating. As previously noted, if a sleeve was made where the seams were not completely joined, it may be desirable to completely join the seams after the sleeve has been completely fitted over the wire frame. For example, if only the top half of the right and left seams were joined, that portion of the sleeve would correspond to the back of the chair. Once fitted over the sleeve, the bottom half of the right and left seams could be joined so that portion of the sleeve would correspond to the bottom of the chair. In this way, it may not be necessary to cut holes from the sleeve at all.

More than one sleeve may be used in making the chair. For example, a chair may be constructed which uses one sleeve to form the back and bottom and two sleeves which form two armrests that are joined to the chair.

The assembly comprising the wire frame and the sleeve appropriately positioned about the frame is then baked or heated at a high temperature. Generally, the baking is performed in an oven at temperatures between from about 350° F. to about 450° F., and preferably 400° F. The assembly is baked for a period of between from about 1 minute to about 10 minutes, and preferably about 3 minutes. However, the present invention process includes any suitable temperature or time that results in shrinkage of the sleeve member(s). While the fiber sheet is being heated, additional steps such as clamping, tensioning, or molding may also be performed to form the sleeve into a desired shape. The assembly is then removed from the oven and allowed to cool, usually by cooling at ambient temperatures or by blowing air past it. Due to the heating and cooling, the fibers in the fabric sheet bond to the wire frame and shrink, which results in a tight fit and an aesthetically pleasing look. The sleeve becomes rigid, but remains somewhat pliable.

Not wishing to be limited to any particular theory, it is believed that the increased strength characteristics imparted to the chair result from the sleeve having shrunk about the frame of the article, thereby inducing a stress in the frame. The type of stress, i.e. compressive or tensile, and the degree of stress induced to the frame depends upon a host of factors such as, but not limited to, the configuration of the frame, the relationship and positioning of the sleeve about the frame, the degree of shrinkage of the sleeve, and the rigidity of the frame prior to receiving the sleeve shrunk about it.

FIG. 6 illustrates a chair 500 made in accordance with the noted process, after heating. Upon comparison with FIG. 3, it can be seen that the sleeve 200 has shrunk and fits tightly over the wire frame 10. Upon comparison of FIGS. 1, 2, 3, and 6, it can also be seen that in this exemplary embodiment, the sleeve makes two 90-degree turns as it is fitted over the wire frame 10. One 90-degree turn occurs at the intersection of the back of the chair and the seat of the chair; the other occurs at the front of the chair where the sleeve ends and covers the front cross support 40. These turns, when present, also “lock” the sleeve onto the frame after hearing and cooling. As a result, the sleeve cannot be pulled off or removed. This reinforces the bonding and shrinking of the sleeve onto the wire frame. One 90-degree or other significant turn would accomplish a similar “locking” feature. However, a 90-degree or bend turn is not required in the present invention.

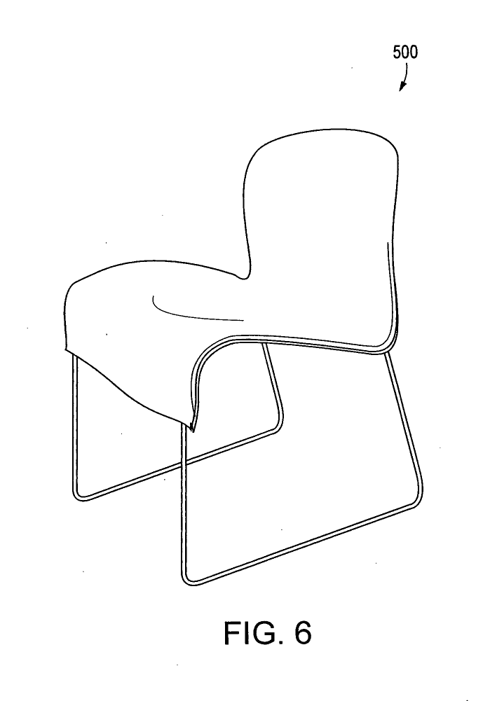

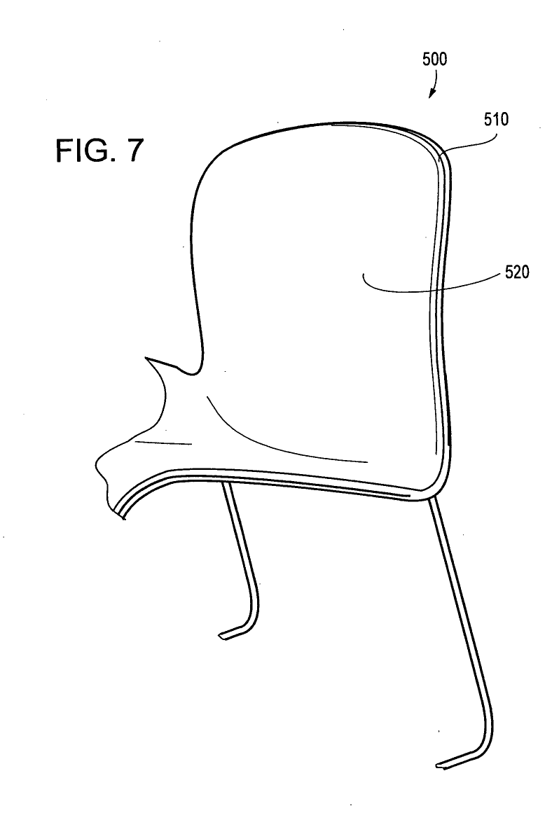

FIG. 7 is a detail showing the surface 520 detail of the sleeve after cooling. Preferably, the surface is relatively smooth. However, it will be appreciated that the present invention includes versions in which textured patterns are imparted or otherwise provided on the outer surface of the article or sleeve. Additionally, the chair 500 is shown as including a recessed valley or indentation 510 extending along the perimeter or outer periphery of the sleeve. This valley 510 can serve to further secure the sleeve to the frame, or at least to promote the aesthetics of the chair. The valley or indentation can be molded or otherwise produced during the heating process. A sewn seam can be located to extend within the valley 510.

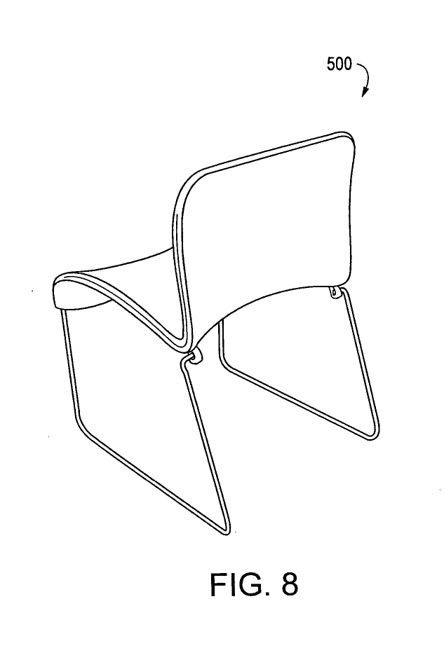

FIG. 8 illustrates the final chair 500 from the rear. If desired, holes or other apertures may be drilled or formed in the rigid sleeve to expose parts of the wire frame located within the sleeve. Here, holes were formed to provide access for joining the rear legs of the wire frame. However, drilling holes is not necessary to practice the invention.

The present invention method was described with reference to making a chair. The same method or a similar method may be used to make other articles of furniture including, but not limited to, sofas, benches, and the like. The present invention process may be used to make pieces or components of furniture, such as the back, bottom, or armrests, which are then joined together to make an article of furniture. The present invention process may also be applied to lighting products and other architectural or ornamental products such as room dividers, wall panels, sculptures and the like.

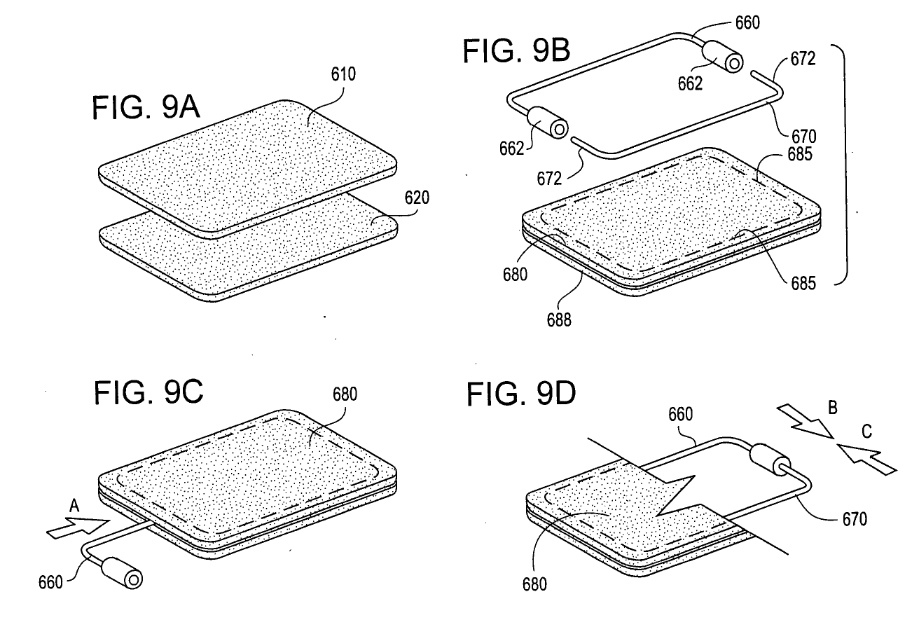

The present invention also provides a unique strategy for producing panels with internal frames having a flexible or rigid sleeve or outer covering. As illustrated in FIGS. 9A-9D, a collapsible frame is incorporated within one or more sleeve members and upon suitable positioning within the sleeve, the frame is expanded or assembled, or at least partially so, to thereby draw the sleeve member about the frame. The resulting panel or product can be utilized in that form. However, it is generally preferred that the sleeve is formed of a heat shrink nonwoven fiber, and upon assembly of the frame therein, is heated to thereby draw or tighten the sleeve about the expanded frame.

Specifically, referring to FIG. 9A, at least two sheets or layers 610 and 620 of a heat shrink fiber are positioned to form a sleeve. In FIG. 9B, at least one expandable frame assembly is provided, such as frame components 660 and 670. As will be understood, the components 660 and 670 preferably include one or more interlocking ends such as male ends 672 and female receiving ends 662. At least a majority of the outer periphery of the layers 610 and 620 are joined to each other to thereby form a sleeve 680. Such joining can be provided by a region of stitching or adhesive 685. It is significant that at least one region along the periphery of the sleeve 680 not be joined, so that an aperture of region 688 for accessing the interior of the sleeve 680 is provided. FIG. 9C illustrates insertion of the frame component 660 within the interior of the sleeve 680 through the aperture 688. The frame component 660 is inserted through the aperture 688 in the direction of arrow A. The other frame component 670 (not shown in FIG. 9C) is residing within the interior of the sleeve 680. This method can be performed by first forming the sleeve and then inserting the frame components therein. Or, the method can be performed by forming the sleeve while the frame components are directly incorporated therein. FIG. 9D illustrates expansion or assembly or the frame within the sleeve. The frame components 660 and 670 are interlocked or otherwise engaged with each other. This may be accomplished by applying force at the respective ends, such as in the directions of arrows B and C.

The present invention includes the use of other types of expandable frame assemblies that can be incorporated in heat shrinkable sleeve or flexible members. For example, a circular ‘hub’ connector could support many identical frames arranged radially to form a ‘lathed’ shape, or a spherical shape. In this case, several sewn sheets of fiber could form a skin surrounding the spherical frame. Once heated and hardened, the metal frame could potentially be collapsed by removing the hub and then removing the radial frame (spokes) from a hole in the formed skin. This would be a similar shrink-wrap process, with a very different outcome.

It will be appreciated that although the frame embodiment 10 is generally referred to and shown in the description of the various aspects of the present invention, frames 10a and 10b could be used.

The exemplary embodiments have been described with reference to the preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A method of manufacturing an article of furniture from at least one flexible sleeve that shrinks upon being heated and a frame, comprising the steps of:
fitting said at least one sleeve onto said frame so that said frame is located within said sleeve to form an assembly;
heating said assembly to thereby shrink said sleeve about said frame; and
cooling said assembly to thereby harden said sleeve.

2. The method of claim 1, wherein said at least one sleeve is formed from a layer of a nonwoven fiber, the layer having at least two of its edges secured together prior to the heating step.

3. The method of claim 2, wherein said at least one sleeve is formed from a needle-punched nonwoven fiber.

4. The method of claim 2, wherein said at least one sleeve comprises a fiber selected from the group consisting of polyester, polyvinyl chloride, polyolefin, polyimide, and combinations thereof.

5. The method of claim 2, wherein said fiber has a weight of between about 30 ounces to about 60 ounces.

6. The method of claim 1, wherein said frame comprises a material selected from the group consisting of iron, steel, fiberglass, plastic, and wood.

7. The method of claim 1, wherein said step of heating the assembly is performed by heating the assembly at a temperature of between 350° F. and 450° F.

8. The method of claim 1, wherein said step of heating the assembly is performed by heating the assembly for a period of time between from about 1 minute to about 10 minutes.

9. The method of claim 1, wherein said method further comprises a step of shaping the sleeve by using a method selected from the group consisting of clamping, tensioning, and molding.

10. The method of claim 1 wherein after said heating, the sleeve shrinks by an amount of from 1% to about 15%.

11. The method of claim 10 wherein the sleeve shrinks by an amount of from about 2% to about 10%.

12. The method of claim 11 wherein the sleeve shrinks by an amount of from about 4% to about 8%.

13. An article of furniture manufactured according to the method of claim 1.

14. A method of manufacturing a chair from a sleeve exhibiting heat shrink characteristics and a three-dimensional wire frame, comprising the steps of:
fitting said sleeve onto said wire frame so that said wire frame is located within said sleeve to form an assembly;
heating said assembly to a temperature in the range of from about 350° F. to about 450° F. for a period of time sufficient to cause said sleeve to shrink about said frame; and
cooling said assembly.

15. The method of claim 14 wherein said sleeve is formed from a nonwoven fiber selected from the group consisting of polyester, polyvinyl chloride, polyolefin, polyimide, and combinations thereof.

16. The method of claim 14 wherein said sleeve shrinks by an amount of from about 1% to about 15%.

17. An article of furniture manufactured according to the method of claim 14.

18. A method of forming an article having an internal frame disposed within a flexible heat-shrinkable sleeve, the method comprising:
providing an expandable frame assembly;
providing a flexible heat-shrinkable sleeve;
inserting the frame assembly in the sleeve;
expanding the frame assembly within the sleeve; and
heating the sleeve to thereby cause the sleeve to contract about the expanded frame.

19. The method of claim 17 wherein said sleeve is formed from a nonwoven fiber selected from the group consisting of polyester, polyvinyl chloride, polyolefin, polyimide, and combinations thereof.

20. The method of claim 17 wherein said sleeve shrinks by an amount of from about 1% to about 15%.

21. The article produced according to the method of claim 18.

22. A furniture article consisting of:
a frame; and
a sleeve member disposed about the frame, the sleeve member exhibiting a heat shrink property and having been heated to thereby induce shrinkage of the sleeve about the frame to thereby secure the sleeve member to the frame.

23. The furniture article of claim 22, wherein the sleeve member includes at least one layer of material different than the material exhibiting the heat shrink property.

24. An article of furniture comprising:
a frame defining a seat region, a back region, and a plurality of legs extending from the seat region and adapted for supporting the frame;
a sleeve member extending within at least one of the seat region and the back region, and secured to said at least one of the seat and back regions, the sleeve member including a heat-shrinkable material that upon exposure to a temperature in the range of from about 350° F. to about 450° F., shrinks by an amount of from about 1% to about 15%.

25. The article of claim 24 wherein the heat-shrinkable material includes a nonwoven fiber selected from the group consisting of polyester, polyvinyl chloride, polyolefin, polyimide, and combinations thereof.
